(19) United States
(12) Patent Application Publication
(10) Pub. No.: US 2026/0080220 A1
(43) Pub. Date: Mar. 19, 2026

(54) Fast Generation from Convolutional Sequence Models

(71) Applicant: GDM Holding LLC, Mountain View, CA (US)

(72) Inventors: Elad Hazan, Princeton, NJ (US); Naman Agarwal, Jersey City, NJ (US); Daniel Can Suo, Princeton, NJ (US); Xinyi Chen, Princeton Junction, NJ (US); Evan Andrew Dogariu, New York City, NY (US); Vladimir Iouri Feinberg, San Francisco, CA (US)

(21) Appl. No.: 19/330,724

(22) Filed: Sep. 16, 2025

Related U.S. Application Data
(60) Provisional application No. 63/695,076, filed on Sep. 16, 2024.

(51) Int. Cl. G06N 3/0464

(52) U.S. Cl. CPC G06N 3/0464

(57) ABSTRACT

Provided are fast auto-regressive generation of sequence prediction models. For sequence prediction models that are based on convolutional operators, such as spectral state space models, example implementations reduce generation time from linear in the context length to square root of the context length.

### RELATED APPLICATIONS

This application claims priority to and the benefit of U.S. Provisional Patent Application No. 63/695,076, filed Sep. 16, 2024, and titled “Fast Generation from Convolutional Sequence Models.” U.S. Provisional Patent Application No. 63/695,076 is hereby incorporated by reference in its entirety.

### FIELD

The present disclosure relates generally to machine learning processes and machine-learned devices and systems. More particularly, the present disclosure relates to fast generation from convolutional sequence models.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method for performing autoregressive generation with a convolutional sequence model. The computer-implemented method also includes obtaining, by a computing system which may include one or more computing devices, a current context vector which may include a plurality of context data items; pre-computing, by the computing system, a convolution between the input context and a filter of the convolutional sequence model to pre-cache a plurality of inner products respectively between the filter and a plurality of padded context vectors; and for each of a plurality of output values: determining, by the computing system, the output value based on a sum of one of the pre-cached inner products with one or more additional component products respectively generated by multiplication of the filter with one or more preceding context data items that precede the output value. Other embodiments of this aspect include corresponding computer systems, apparatus, and computer programs recorded on one or more computer storage devices, each configured to perform the actions of the methods.

Example implementations may include any combination of one or more of the following features. The computer-implemented method, where, for a first sequential output value of the plurality of output values, the one or more preceding context data items may include of a final context data item of the plurality of context data items. For a second or later sequential output value of the plurality of output values, the one or more preceding context data items may include of a final context data item of the plurality of context data items and all preceding output values of the plurality of output values. The computer-implemented method may include updating, by the computing system, the current context vector to include the plurality of output values. Pre-computing the convolution may include performing a fast Fourier transform algorithm. The filter of the convolutional sequence model may include a spectral filter. The filter of the convolutional sequence model may include a fixed-value filter. Determining each output value may include determining the output value further based on multiplication of one or more learned projection matrices and the sum. Pre-computing the convolution may include generating the plurality of padded context vectors by padding respective subportions of the current context vector. The current context vector may include textual tokens associated with a textual content. The current context vector may include a sequence embedding generated by one or more preceding layers of the convolutional sequence model that precede a spectral analysis layer that includes the filter. Each output value may include a classification output. Each output value may include a predicted token. Determining, by the computing system, the plurality of output values may include performing batch generation of output values. Said operations of obtaining the current context vector, pre-computing the convolution, and determining the plurality of output values may be iteratively performed over a number of online generation periods. For a second or later online generation period, the current context vector for that online generation period may include at least in part a preceding window of outputs generated by the convolutional sequence model. The online generation periods may have a periodicity equal to a threshold number of output values. The threshold number of output values may be equal to a square root of a context length associated with the filter. Each online generation period further may include evaluating, by the computing system, a loss function that compares the output values to ground truth values. The threshold value may be equal to a square root of a context length associated with the filter. Implementations of the described techniques may include hardware, a method or process, or computer software on a computer-accessible medium.

One general aspect includes one or more non-transitory computer-readable media that collectively store computer-executable instructions for performing operations. The operations may include determining whether an output counter exceeds a threshold value; when the output counter satisfies the threshold value: pre-computing, by the computing system, a convolution between a current context vector and a filter of a convolutional sequence model to pre-cache a plurality of inner products respectively between the filter and a plurality of padded context vectors; and resetting the output counter. The operations may include when the output counter does not satisfy the threshold value: determining, by the computing system, a next sequential output value based on a sum of one of the pre-cached inner products with one or more additional component products generated by multiplication of the filter with one or more preceding context data items; updating the current context vector to include the next sequential output value; and increasing the output counter. Other embodiments of this aspect include corresponding computer systems, apparatus, and computer programs recorded on one or more computer storage devices, each configured to perform the actions of the methods.

One general aspect includes a computing system for processing a sequence of data items corresponding to a plurality of time steps. The computing system includes a neural network model and is configured to perform operations for successive time steps. The operations may include processing an initial item embedding based on the data item for the time step using an analysis network of the neural network model may include a plurality of processing layers arranged in a sequence, each processing layer performing a function defined by a corresponding set of trained numerical parameters, a first processing layer of the sequence being configured to receive the initial item embedding, and to output a corresponding modified item embedding, and each other processing layer of the sequence being configured to receive the item embedding output by the preceding layer of the sequence and output a corresponding modified item embedding; where at least one of the processing layers is a spectral analysis layer which, for each generation period that spans a plurality of time steps: obtains a current context vector may include a plurality of context data items; pre-computes a convolution between the input context and a filter of the convolutional sequence model to pre-cache a plurality of inner products respectively between the filter and a plurality of padded context vectors; and for each of the plurality of time steps: determines an output value for that time step based on a sum of one of the pre-cached inner products with one or more additional component products respectively generated by multiplication of the filter with one or more preceding context data items associated with preceding time steps. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is a graphical diagram of an example application of a convolutional filter to an input sequence according to example implementations of aspects of the present disclosure;

FIG. 2 is a graphical diagram of an example epoched application of a convolutional filter to an input sequence according to example implementations of aspects of the present disclosure;

FIG. 3 is a graphical diagram of an example quasilinear online application of a convolutional filter to an input sequence according to example implementations of aspects of the present disclosure;

FIG. 4 is a flow chart diagram illustrating an example method for training a machine-learned model according to example implementations of aspects of the present disclosure;

FIG. 5 is a block diagram of an example processing flow for using machine-learned model(s) to process input(s) to generate output(s) according to example implementations of aspects of the present disclosure;

FIG. 6 is a block diagram of an example sequence processing model according to example implementations of aspects of the present disclosure;

FIG. 7 is a block diagram of an example technique for populating an example input sequence for processing by a sequence processing model according to example implementations of aspects of the present disclosure;

FIG. 8 is a block diagram of an example model development platform according to example implementations of aspects of the present disclosure;

FIG. 9 is a block diagram of an example training workflow for training a machine-learned model according to example implementations of aspects of the present disclosure;

FIG. 10 is a block diagram of an inference system for operating one or more machine-learned model(s) to perform inference according to example implementations of aspects of the present disclosure;

FIG. 11 is a block diagram of an example networked computing system according to example implementations of aspects of the present disclosure;

FIG. 12 is a block diagram of an example computing device according to example implementations of aspects of the present disclosure; and

FIG. 13 is a block diagram of an example computing device according to example implementations of aspects of the present disclosure.

### DETAILED DESCRIPTION

### Overview

In various sequence processing and prediction tasks, large transformer models are extensively utilized due to their sophisticated attention mechanisms. However, these models encounter a significant technical problem related to computational efficiency. Specifically, the attention operator, a central component of these models, incurs a quadratic computational cost during the inference phase. This computational complexity not only demands substantial processing power but also limits the scalability of these models, particularly when dealing with long sequence data.

Sequence prediction models based on long convolutions have emerged as a strong alternative, owing to their fast computation during training via the Fast Fourier Transform (FFT) algorithm which scales almost linearly in the sequence length.

The recent surge of interest in convolutional sequence models has emerged from the success of State Space Models (SSM) which have shown promise in modelling long sequences in diverse modalities. Convolutional models are a more general class of predictors than SSMs as they can represent any linear dynamical system (LDS) and are not bottlenecked in their memory capacity by the dimensionality of the hidden state as is the case for SSMs. As a result, recent advancements in convolutional sequence models have emerged that are able to theoretically and empirically cope with longer contexts. These include the spectral state space models, or STU (spectral transform units), which uses the spectral filtering algorithm to transform the input into a basis that is better conditioned to handle longer memory. Another approach, referred to as “Hyena”, learns an implicitly parameterized Markov operator. Both techniques are based on convolutional predictors, namely they filter the sequence to make future predictions. Thus, they can exploit the duality between convolution in the time domain and multiplication in the spectral domain, for faster prediction using the Fast Fourier Transform.

SSMs or recurrent models in general, have the advantage of fast inference (independent of sequence length), making them an attractive choice for large scale language modelling. While convolutional models can be more general in terms of representation, the best known result for generating tokens from such models during inference is known to be as slow as an attention-based model, that is, quadratic in sequence length.

In view of these challenges, the present disclosure provides systems and methods for autoregressive generation with convolutional sequence models, specifically designed to boost computational efficiency at inference-time for sequence prediction tasks such as, for example, language modeling. One aspect of the proposed approach includes the pre-computation of a convolution between a filter of the convolution sequence model and a current input context. The pre-computation allows the inference system to pre-cache inner products between the filter and a plurality of padded context vectors generated from the current context vector. Then, for each output value, the inference system can efficiently fetch one of these pre-cached inner products and supplement it with one or more additional component products. By pre-computing the convolution, the proposed approach reduces the computational complexity from linear to proportional to the square root of the context length, significantly lowering the computational resources needed to perform sequence prediction tasks. As such, by streamlining the generation process, the proposed approach supports longer sequences and improves real-time processing capabilities, making it highly advantageous for applications requiring quick and precise sequence predictions.

More particularly, one aspect of the present disclosure is directed to a computer-implemented method for autoregressive generation with a convolutional sequence model. For example, this method can be applied to tasks such as language modeling, machine translation, or any application requiring sequence prediction. For example, the method can leverage convolutional sequence models to predict future sequence elements based on a current context vector, which includes a series of previous sequence elements.

The technology can include a step where a computing system obtains a current context vector comprising a plurality of context data items. This vector can serve as the input for the convolutional sequence model for a current inference stage, and the context vector can include various types of data, such as numerical values, text tokens, and/or even more complex data structures, depending on the specific application. For instance, in language processing tasks, the context vector might contain tokens or embeddings that correspond to the last few words or sentences that have been processed. In some implementations, the current context vector can be represented as u_{1:L}.

Another aspect of the technology involves pre-computing a convolution between the input context and a filter of the convolutional sequence model to pre-cache a plurality of inner products. This step can utilize computational techniques like the Fast Fourier Transform (FFT) to expedite the convolution process. The pre-cached inner products can be between the filter and a plurality of padded context vectors, which can help in preparing the system for quick generation of subsequent output values. In some implementations, this pre-computation can be represented as ∀τ∈{1, . . . , K}, C_{τ}← [symbol] Φ_{1:L+τ},0_{τ}u_{L:1} [symbol] , where K represents a number of output values, Φ represents the filter, 0_{τ} represents zero padding of length τ, and C_{τ} represents a member of a cache {C₁ . . . Cₖ}, Cᵢ∈ [symbol] .

In some implementations, for each output value generation, the present disclosure can include determining the output value based on a sum of one of the pre-cached inner products with one or more additional component products. These component products can be generated by the multiplication of the filter with one or more preceding context data items that precede the output value. In particular, the preceding context data items can include preceding output values that were previously predicted at a prior time step. In some implementations, the output value generation process can be represented as:

for τ = 1, ... , K, let t = L + t do
$Compute and predict : {\hat{y}}_{t} = {\sum }_{j = 1}^{t} {Φ}_{j} {u}_{t - j + 1} = {\sum }_{j = 1}^{τ} {Φ}_{j} {u}_{t - j + 1} + 〈 {Φ}_{τ + 1 : t} , {u}_{L : 1} 〉$
end for

In the above expression, ŷₜ represents the generated output value for step t, [symbol] φ_{τ+1:t}, u_{L:1} [symbol] represents the inner product retrieved from the cache (and therefore can also be represented as C_{τ}), and the Φⱼuₜ₋ⱼ₊₁ for each j represents an additional component product. As noted, the additional component products can be generated by multiplication of the filter with one or more preceding context data items that precede the output value. For example, the uₜ₋ⱼ₊₁ for τ>1 and j<τ can be an output value predicted at a prior time step t, for example which may be represented as ŷₜ₋ⱼ.

An output value can be a final prediction (e.g., a classification prediction or other output such as a predicted output token). Alternatively, an output value can be an intermediate output (e.g., an embedding that is output by a layer containing the filter and which is further processed by a downstream portion of the model).

The method can further include updating the current context vector to include the generated output values. For example, after each output value is generated it can be appended to the current context vector to update the current context vector for a subsequent step.

In some implementations, the filter used in the convolutional sequence model can be a spectral filter and/or a fixed-value filter. In other implementations, the filter can be parameterized and include a set of learned values. The choice of filter can depend on the specific requirements of the application. Spectral filters, for example, can be particularly useful for tasks requiring analysis of data over various frequencies.

In some implementations, the convolutional sequence model can include multiple filters. For example, the multiple filters can be represented as Φ₁, . . . , Φₖ. The multiple filters can be applied to an input in parallel and/or in sequence.

In some implementations, the convolutional sequence model described in the present disclosure can also include one or more learned projection matrices. For example, one example implementation can compute generate a prediction according to the following expression:

$${\hat{y}}_{t} = σ ( {\sum }_{i = 1}^{k} {M}_{i} 〈 {Φ}_{i} , {u}_{t : t - L} 〉 )$$

where Φᵢ are the filters (e.g., which may be fixed values such as eigenvectors), M_{1:k} are learned projection matrices, and σ is a nonlinear gate. Thus, learned matrices can be used in determining each output value, further enhancing the model's ability to tailor its predictions based on learned data characteristics from past computations.

In some implementations, the technology can be adapted for batch generation of output values. This adaptation can be useful in scenarios where a set number of output values are needed at once, such as generating a fixed number of forecast points in a weather prediction model or tokens for a text generator.

However, according to another aspect of the present disclosure, the proposed techniques can also be configured for iterative performance over a number of online generation periods. In such configurations, for each subsequent online generation period, the current context vector might include, at least in part, a preceding window of outputs generated by the convolutional sequence model. This iterative approach can be beneficial in continuous data processing tasks, such as ongoing monitoring and prediction in industrial processes.

In particular, in some implementations, a convolutional sequence model can operate in an online fashion over a plurality of iterations. Each iteration can include several steps to perform output generation.

In some implementations, each online iteration begins by determining whether an output counter exceeds a threshold value. In some implementations, this threshold is set to the square root of the context length associated with the filter. A threshold of this value optimizes the balance between computational efficiency and the responsiveness of the model.

When the output counter meets or exceeds this threshold value, the system pre-computes a convolution between the current context vector and a filter of the convolutional sequence model. This step involves generating and storing a series of inner products between the filter and various padded versions of the context vector, effectively pre-caching these results for quick access in subsequent operations, for example as described above. Following this, the output counter is reset, preparing the system for the next cycle of output generation.

However, if the output counter does not satisfy the threshold value, the system proceeds to generate the next sequential output value. This can be achieved by summing one of the pre-cached inner products with one or more additional component products, which are generated by multiplying the filter with one or more preceding context data items (which may in some cases include preceding output values), for example as described above. This method allows for the rapid calculation of the next output value, thereby saving computational resources. After determining the output value, the current context vector is updated to include this new output, ensuring that the context used in future iterations is current. Finally, the output counter is incremented, progressing the system closer to the next threshold check and potential pre-computation phase.

Thus, example implementations of the online method can incorporate a strategic approach to periodically re-compute (or pre-compute) a convolution between a filter of a convolutional sequence model and an input, thereby enabling the pre-computation of certain inner product components which enable the prediction of output values with improved efficiency. Each cycle of operations from the point of reaching the threshold value, performing the pre-computation, and resetting the output counter until the threshold is reached again, constitutes what can be referred to as an “online generation period.” Specifically, during each online generation period, the system evaluates whether the output counter exceeds the threshold. If it does, the system executes the pre-computation of the convolution. Once the pre-computation is complete and the output counter is reset, the system enters a phase where it continues to generate output values based on the pre-cached data. This phase lasts until the output counter again reaches the threshold, marking the end of the current online generation period and the beginning of a new one. The periodicity of these online generation periods, therefore, is controlled by the threshold value.

Lastly, some example implementations can further include evaluating a loss function that compares the output values to ground truth values and updating one or more parameters of the model based on the loss function. This evaluation can help in continuously improving the accuracy of the predictions by adjusting the model parameters based on the observed discrepancies between the predicted and actual values.

The proposed techniques provide a number of technical effects and benefits. As one example, the proposed technology significantly enhances computational efficiency in processing sequence prediction tasks, particularly in language modeling and machine translation. This efficiency is achieved through the efficient pre-computation of values for use when generating outputs from a convolutional sequence model. This efficient pre-computation can reduce the computational cost from a quadratic dependency on the context length to a more manageable form. For example, the use of FFT allows convolutional sequence predictors to generate output in time proportional to the square root of the context length, which is a substantial improvement over traditional methods that require time linear in the context length.

As another example technical effect and benefit, the proposed technology can provide enhanced scalability for applications requiring real-time processing of extensive sequential data. By optimizing the computational resources and handling longer contexts efficiently, the technology enables the deployment of sequence processing models in more demanding environments. For instance, real-time communication platforms, live language translation services, and interactive AI systems can benefit from this increased scalability, allowing them to operate smoothly without delays attributable to data processing bottlenecks.

### Example Setting

Example Notation: For an input sequence {uₜ} some example implementations denote by u_{1:t} the sequence of inputs u₁, . . . , uₜ. For any i≤j let u_{i:j} denote the sub-sequence uᵢ, uᵢ₊₁, . . . uⱼ. When i>j, u_{i:j} denotes the subsequence u_{j:i} in reverse order. Some example implementations also denote [k]={1, 2, . . . , k} as a set of k natural numbers. For a vector u, let [u]ⱼ denote the j-th coordinate of u; if u is a one-dimensional sequence, then let [u]ⱼ denote the j-th position of u. Given a multi-dimensional sequence u₁ . . . uₜ where each uᵢ∈^{d} and given a vector v∈ [symbol] ^{t}, for brevity some example implementations overload the definition of inner products by defining y= [symbol] v, v_{1:t} [symbol] with y∈ [symbol] ^{d} as

$${y}_{j} = {\sum }_{i = 1}^{t} {v}_{i} \cdot {[ {u}_{i} ]}_{j} ∈ ℝ .$$

That is, y is a d-dimensional vector where the coordinate j is the inner product between v and the sequence [u₁]ⱼ, . . . , [uₜ]ⱼ.

Example Convolution: The convolution operator between two vectors u, φ∈ [symbol] ^{t} outputs a sequence of length t whose element at any position s∈[t] is defined as

$$[ u * ϕ ] ( s ) = {\sum }_{i = 1}^{s} {u}_{i} {ϕ}_{s + 1 - i} = 〈 {u}_{1 : s} , {ϕ}_{s : 1} 〉 . \qquad ( 1 )$$

A classical result in the theory of algorithms is that given two vectors u, φ∈ [symbol] ^{t}, their convolution can be computed in time O(t log t), using the FFT algorithm.

Example Online Convolution: Some example implementations consider the problem of performing the convolution u*φ when one of the sequences φ is fully available to the algorithm, however the other sequence u streams in—the element uₜ is made available to the algorithm at the start of round t, at which point it has to release the output [u*φ]ₜ. This model of online convolution is immediately relevant to the online auto-regressive generation of tokens from a convolutional sequence model, as the output token at time t becomes the input for the next round. In this setting, the sequence u corresponds to generated tokens and the sequence φ corresponds to the convolutional filter which is known to the model.

Example Naive Online Convolution: Online convolution can be implemented by directly computing the inner product at each time step, as the new input becomes available. This method can be referred to as naive online convolution. It has a computational complexity of O(L²) for predicting for L steps and requires no additional memory beyond storing the inputs and filters.

### Example Auto-Regressive Sequence Prediction

Example Sequence Prediction: In this setting, the input is a sequence of tokens denoted u₁, . . . , uₜ, . . . , where uₜ∈ [symbol] ^{d}^{ᵢₙ}. The predictor's task is to generate a sequence ŷ₁, . . . , ŷₜ, . . . , where ûₜ∈ [symbol] ^{d}^{ₒᵤₜ} is generated after observing the inputs u₁, . . . , uₜ₋₁. The output yₜ is observed after the predictor generates ŷₜ. The quality of the prediction can be measured by the distance between the predicted and observed outputs according to a loss function [symbol] ₜ(ŷₜ,yₜ), for example the [symbol] ₂ distance ∥ŷₜ−yₜ∥².

Example Auto-regressive Sequence Prediction: When predicting a sequence in an auto-regressive fashion, in each iteration an online predictor first makes a prediction using the existing inputs u₁, . . . , uₜ₋₁, and then append the prediction It to the inputs to be used in the next iteration, where the inputs become u₁, . . . , uₜ₋₁, ŷₜ. When predicting from scratch, the online predictor starts from a given initial token and predicts, or generates, the rest of the sequence.

Example Auto-regressive Sequence Prediction from a Prompt: Auto-regressive sequence prediction starting from a prompt is commonly used by large language models. Herein the sequence model has to generate a specified number of tokens given a certain context. In practice, this setting consists of two stages, the prefill stage and the decode stage.

During prefill, the model ingests the entire context and generates a cache that stores context information required for generation. When decoding, the model takes the cache and the most recently generated token as input and generates the next output token. The cache is then updated with the most recent input token. The cache stores the input information the prediction algorithm needs in order to generate the output. For instance, Transformers typically save the key and value vectors of past inputs in a KV cache, and for convolutional models, naive online convolution stores all previous inputs. As a result, for these models, generating K tokens from a prefill of length L requires a cache of size O(L+K). This can be prohibitively large for long-context inference with an extensive prompt, and reducing the cache size is key in this setting.

### Example Online Convolutions in Sequence Prediction

Some example implementations define a convolutional sequence prediction model to be given by a filter, which is a vector denoted by φ∈ [symbol] ^{L} where L is the context length of the model. It takes as an input a sequence u, and outputs a prediction at time t according to the following equation, ŷₜ= [symbol] φ, u_{t:t-L} [symbol] .

The above definition can be extended to include nonlinearities and multiple filter channels. Example proposed online convolution techniques can be straightforwardly applied to all the following models, leading to an improvement in the generation time from O(L²) to Õ(L). When generating from a prompt, some example implementations improve the cache size from O(L+K) to O(K).

Spectral Transform Units: The STU architecture is based on the spectral filtering technique for linear dynamical systems. These are convolutional sequence models based on carefully constructed filters that are not data-dependent. More specifically, the filters φ₁, . . . , φₖ are derived from a fixed Hankel matrix H_{L} depending only on the sequence length L. The STU predicts according to the following rule

$${\hat{y}}_{t} = {\sum }_{i = 1}^{k} {M}_{i} 〈 {ϕ}_{i} , {u}_{t : t - L} 〉 ,$$

where M_{1:k} are learned projection matrices. Note that the inner products [symbol] φᵢ, u_{t:t-L} [symbol] are the outputs of φᵢ*u. The STU architecture is particularly appealing for learning LDS with long memory, as demonstrated by its dimension-free sublinear regret guarantees for this setting.

Hyena: The Hyena architecture proposed in Poli et al. (Hyena hierarchy: Towards larger convolutional language models. In International Conference on Machine Learning, pages 28043-28078. PMLR, 2023) sequentially applies convolutions and element-wise products in an alternative fashion. Formally, given an input u_{1:t}, N+1 linear projections v, x₁, . . . x_{N} of the input are constructed (similar to the q, k, v sequences in self-attention). The hyena operator as a sequence of convolutions with learnable filters h₁ . . . h_{N} is then given by

$$y = {x}_{N} \cdot ( {h}_{N} * ( {x}_{N - 1} \cdot ( {h}_{N - 1} * ( … ) ) ) ) .$$

### Example Efficient Online Convolutions Using FutureFill

This section begins by introducing a simple and convenient primitive named FutureFill that forms an example building block of example proposed algorithms. Intuitively, FutureFill corresponds to computing the contribution of the current and previously generated tokens on the future tokens yet to be generated. For a convolutional model (and unlike attention) this contribution can be efficiently determined without even having generated the future tokens. Here onwards, for brevity of notation, for any v∈ [symbol] ^{t}, the notation assumes vⱼ=0 for any j≤0 or any j>t. Formally, given two sequences v∈ [symbol] ^{t}^{₁}, w∈ [symbol] ^{t}^{₂} some example implementations define FutureFill (v, w)∈ [symbol] ^{t}^{₂}⁻¹ as

$$∀ s ∈ [ {t}_{2} - 1 ] \qquad {[ FutureFill ( v , w ) ]}_{s} = {\sum }_{i = 1}^{{t}_{2} - s} {v}_{{t}_{1} - i + 1} \cdot {w}_{s + i} .$$

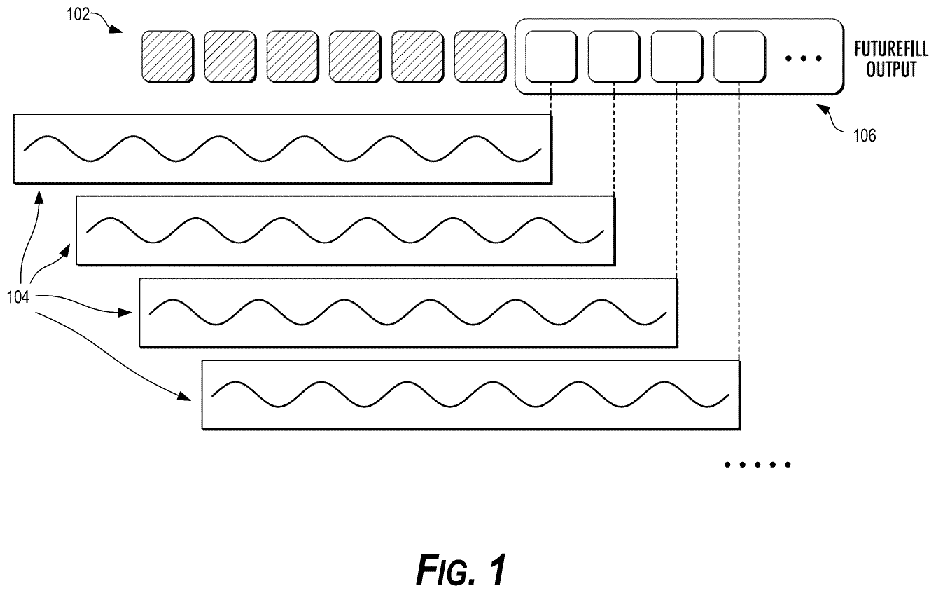

FIG. 1 depicts the FutureFill operation between an input sequence 102 and a convolutional filter 104 to produce an output 106 (e.g., autoregressively). Conceptually, [FutureFill(v, w)]ₛ is the contribution of the input v of length t₁ to the output [v*w] at position t₁+s. The FFT algorithm for convolutions can easily be extended to compute the FutureFill as well in time at most O((t₁+t₂)log(t₁+t₂)). For example, the full mode of a standard conv implementation (e.g., scipy) can be used to compute FutureFill in the following way under Python slicing convention (exclusive of the last index),

$$FutureFill ( v , w ) = scipy . linalg . conv ( v , w , mode = full ) [ t\_ 1 : t\_ 1 + t\_ 2 - 1 ]$$

To leverage FutureFill for efficient generation from a convolutional model, consider the proposition below that follows from the definition of convolution.

Given two vectors a, b∈^{t}, we have that ∀t₁, s∈[t],

$${[ a * b ]}_{s} = \{ \begin{matrix}{[ {a}_{1 : {t}_{1}} * {b}_{1 : {t}_{1}} ]}_{s} & if s \leq {t}_{1} \\ {[ {a}_{{t}_{1} + 1 : t} * {b}_{1 : t - {t}_{1}} ]}_{s - {t}_{1}} & + [ FutureFill ( {a}_{1 : {t}_{1}} , b ) ] s - {t}_{1}\end{matrix}$$

That is, the convolution of two vectors a and b can be broken into a FutureFill operation and another convolution involving b and only the most recent positions of a.

### Example Epoched-FutureFill: Efficient Online Convolution

When computing online convolutions, the FutureFill routine can efficiently pre-compute the effect of past tokens on future ones. Some example implementations leverage this property in the Epoched-FutureFill procedure outlined in Algorithm 1 to compute online convolutions.

Algorithm 1: Epoched-FutureFill: Efficient Online Convolutional Prediction

```
  1. Input: Filter φ ∈^{L}. Input sequence u ∈ [symbol] ^{L}, streaming coordinate-wise. K, the epoch
length.
  2. Set τ = 1. Set FutureFill cache C ∈ [symbol] ^{K} to 0.
  3. for t = 1, 2, ... , L do
  $4. Receive {u}_{t} , and compute output {\hat{y}}_{t} = {\sum }_{j = 1}^{τ} {u}_{t + 1 - j} \cdot {ϕ}_{j} + {C}_{τ} .$
  5. if τ = K then
  6. Compute FutureFill cache C ∈^{K} defined as Cⱼ =
[FutureFill(u_{1:t}, φ_{1:t+K}]ⱼ.
  7. τ ← 1
  8. else
  9. τ ← τ + 1
10. end if
11. end for
```

The following theorem establishes the properties of Epoched-FutureFill and provide a trade-off between the additional memory overhead and total runtime incurred by the algorithm. In particular, the runtime in this trade-off is optimized when the total memory is O(\sqrt{L log L}), leading to a total runtime of O(L^{3/2}\sqrt{log L}).

Theorem: Algorithm 1 computes the online convolution of sequences with length L and runs in total time

$$O ( \frac{{L}^{2} log L}{K} + KL )$$

with a total additional memory requirement of O(K). Setting K=\sqrt{L log L} to minimize the runtime, Algorithm 1 computes online convolution in O(L^{3/2}\sqrt{log L}) total time and O(\sqrt{L log L}) memory.

The running time can include two components. First, at every iteration, line 4 is executed. One term, C_{τ}, has already been computed and saved in line 6, so some example implementations can retrieve it in constant time. The other term is a sum of τ products, which can be computed in time O(τ). Second, every K iterations, some example implementations execute line 6 and update the cache. The FutureFill operation can be computed via the FFT in at most O(L log L) time.

Summing over L iterations, the total computational complexity is

$$\frac{L}{K} ( L log L + {\sum }_{τ = 1}^{K} τ ) = O ( \frac{{L}^{2} log L}{K} + K L ) = O ( {L}^{3 / 2} \sqrt{log L} ) ,$$

where the last equality holds when the cache size K=\sqrt{L log L} is chosen to minimize the sum.

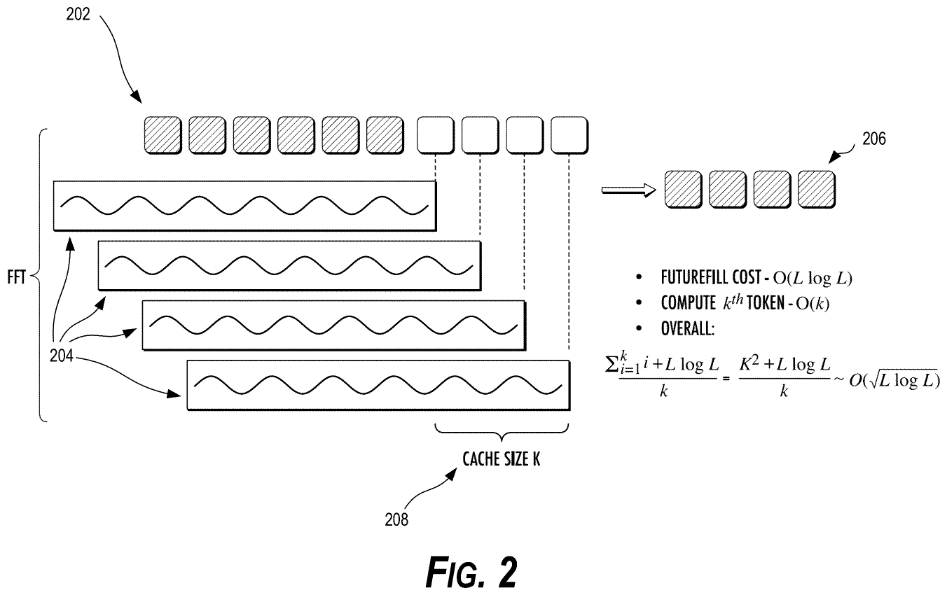

FIG. 2 provides an example illustration of Algorithm 1. Specifically, FIG. 2 illustrates an input 202 being processed with a convolutional filter 204 to generate an output 206. In particular, the computation is performed using the FFT algorithm and using a cache 208.

### Example Continuous-FutureFill: Quasilinear Online Convolution

This section specifies an example procedure that significantly improves upon the runtime of Epoched-FutureFill. A starting point is Proposition 1, which implies that to compute the convolution between two sequences, some example implementations can break the sequences at any point, compute the convolution between the corresponding parts and stitch them together via a FutureFill computation. This motivates the following Divide and Conquer algorithm to compute the convolution of two sequences a, b∈ [symbol] ^{L}
Recursively compute a_{1:L/2}*b_{1:L/2}, a_{L/2+1:t}*b_{1:L/2}.
Output the concatenation of a_{1:L/2}*b_{1:L/2} and (a_{L/2+1:t}*b_{1:L/2})+FutureFill(a_{1:L/2}, b).

Since FutureFill for L-length sequences can be computed in time O(L log L) via the FFT, a standard divide-and-conquer approach yields an O(L log²L) computational complexity for the algorithm. Although this complexity is worse than an FFT, the advantage of the above method is that it can be executed online, i.e. the tokens can be generated as input streams in.

A formal description of an example algorithm implementing this concept is provided as Algorithm 2. Note that the algorithm description essentially serializes the sequence of operations involved in the above divide-and-conquer procedure by their chronological order. For high-level intuition, maintain the divide-and-conquer structure when understanding the algorithm. The algorithm proceeds as follows: at each time step, ŷt= [symbol] u_{1:t},φ_{t:1} [symbol] is returned as a sum of Cₜ, the cache that stores the contribution from past tokens, and uₜ·φ₁, the contribution from token uₜ. In Line 7, the algorithm then computes the contribution of tokens uₜ₋₂_{^{k(t)}}_{+1:t} to positions t+1, . . . , t+2^{k(t)} of [u*φ]. Finally, some example implementations add the output of FutureFill to the existing cache C to accumulate the contributions. In the following theorem a running time bound is provided for Algorithm 2.

Theorem: Algorithm 2 computes the online convolution of sequences with length L and runs in total time O(L log²(L)) with a total additional memory requirement of O(L).

Algorithm 2: Continuous-FutureFill: Quasilinear
Generation From Convolutional Models

| | |
|---|---|
| 1. | Input: Convolutional filter φ ∈ [symbol] ^{L} Input sequence u ∈ [symbol] ^{L}, streaming one coordinate |

every round.

| | |
|---|---|
| 2. | Set b = └logL┘. Set FutureFill cache C ∈ [symbol] ^{L} to 0. |
| 3. | for t = 1 ... L do |
| 4. | Receive uₜ. Output ŷₜ = Cₜ + uₜ · φ₁. |
| 5. | Let k(t) be the highest power of 2 that divides t, i.e. k = max{i ∈ |

[b]: tmod2ⁱ = 0}.

| | |
|---|---|
| 6. | Compute FF = FutureFill(uₜ₋₂^{k(t)}_{+1:t},φ_{1:2}^{k(t)+1}) |
| 7. | Set Cᵢ = Cᵢ + FFᵢ₋ₜ ∀ i ∈ [t + 1, t + 2^{k(t)}] |
| 8. | end for |

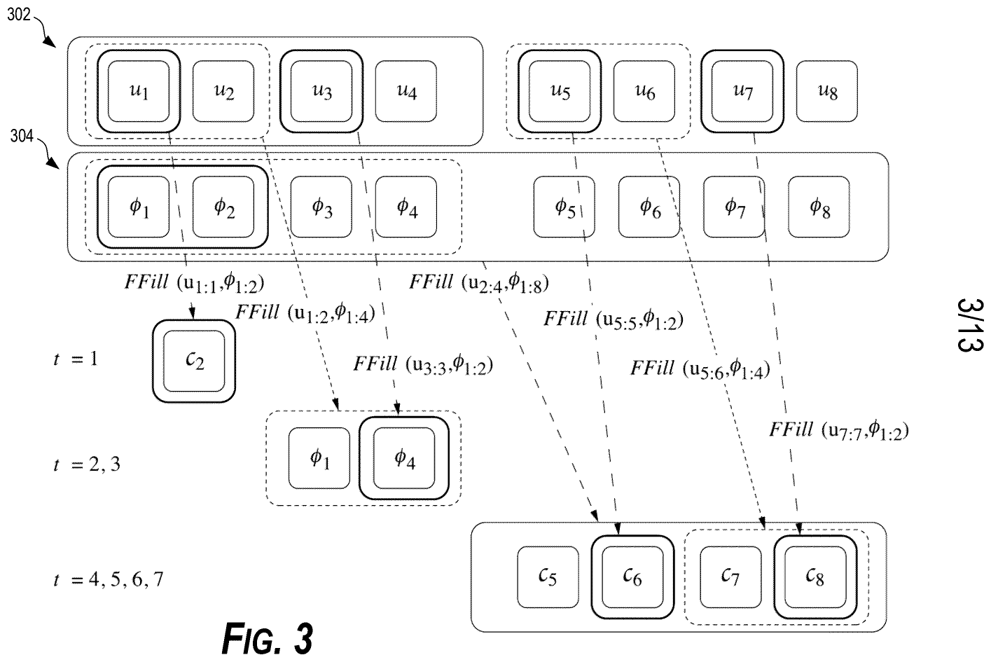

FIG. 3 illustrates an example quasilinear online convolution using FutureFill. In particular, FIG. 3 shows an example execution flow for Algorithm 2 for convolving 8-length sequences. Input sequence u 302 streams in an online fashion and filter φ 304 is fully available to the algorithm. The different line types and line widths around the input sequence 302 and the filter 304 are representative of the size of the FutureFill operations performed and the time t (also coded using different dashed line types) highlights when the FutureFill operations were performed.

### Example Fast Auto-Regressive Sequence Generation from a Prompt

This section considers the problem of auto-regressively generating K tokens starting from a given prompt of length L. For convolutional models in particular, some example implementations define an abstract version of the problem: given a prompt vector p∈ [symbol] ^{L} and a convolutional filter φ∈ [symbol] ^{L+K}, the aim is to iteratively generate the following sequence of tokens:

$${\hat{y}}_{t} = 〈 {\hat{y}}_{1 : t - 1} , {ϕ}_{t - 1 : 1} 〉 + 〈 {p}_{1 : L} , {ϕ}_{t + L - 1 : t} 〉 = {\sum }_{j = 1}^{t - 1} {\hat{y}}_{t - j} \cdot {ϕ}_{j} + {\sum }_{j = t}^{t + L - 1} {p}_{t + L - j} {ϕ}_{j} .$$

As the above definition clearly shows, the expected output is an online convolution where the input sequence u has a prefix of the prompt p and the input sequence is appended by the most recently generated output by the model (i.e. auto-regressive generation). Observe that the output can be computed from a FutureFill operation and another online convolution involving the generated tokens, which can be computed using either of the described online convolution algorithms.

### Example Applications

One example application of the present convolutional sequence model is for the simulation (e.g., prediction of future states of) and/or control of an environment. The environment may be a physical system, such as real-world physical system. The physical system may for example, be a linear dynamic system. In this case, at least some of the context vector (e.g., one or more data items which are at the start of the sequence of data items) may comprise “observation data items”, which are data items characterizing a state of the environment (e.g., sensor data captured by a sensor, such as a (still or moving) camera or a microphone or a medical sensor) at corresponding times, and/or data characterizing inputs (e.g., forces or voltages exerted on) to the environment at those corresponding times. For example, if the environment comprises one or more objects, a given observation data items may characterize the spatial positions, relative spatial positions, orientations and/or relative orientations of the objects at the corresponding time. The outputs of the convolutional sequence model ŷₜ may be predicted observation data items which characterize the state of the environment, e.g., at a current prediction time which is later than the time(s) corresponding to the data item(s) which were used to generate them.

Predicted observation data item(s) ŷₜ generated by the convolutional sequence model from one or more data items at the start of the sequence of data items (e.g., data items which encode sensor data), may be used as, or to generate, data items later in the sequence of data items (“predicted item embeddings”). The predicted item embeddings may be processed by the convolutional sequence model to generate new predicted observation data item(s). In other words, the convolutional sequence model may be used recursively, conditioned on the one or more data items at the start of the sequence of data items, to generate an ongoing sequence of predictions progressively further into the future.

The predictions may be used in various ways. For example, they may be used to generate characterization data which is displayed to a user, and which characterizes the predictions. For example, the characterization data may be classification data indicating that the predictions fall into one or more (e.g., predetermined) categories. For example, the classification data may indicate that the predictions are in one or more categories, e.g., classifications associated with undesirable behaviors of the environment. Upon the convolutional sequence model generating classification data indicating that the predictions are in one of these categories, a corresponding warning may be issued to the user. In one example, if the environment is a system which predicts the future levels of water in a river system based on present measurements and/or data indicating rainfall levels, the classification data may indicate that the predictions are in a category associated with an increased risk of flooding, and based on this classification data a flood warning may be issued to a user, and/or to people located in the region affected by potential flooding.

Another way of using the predictions is to control physical equipment (e.g., an electromechanical system) based on the predicted data items. For example, in the case of controlling water levels in a river system, the predicted data items may be used to control water control apparatus such as a dam, e.g., to reduce the risk of flooding.

Another example of an environment which can be predicted is the weather in a certain geographical location. Based on a weather prediction, a warning can be broadcast to individuals in the geographical location. Furthermore, the convolutional sequence model can be trained on weather forecasts and historical turbine data, to predict wind power output ahead (e.g., 36 hours ahead) of actual generation. The predictions can be used to predict optimal delivery of power to the power grid in advance. This allows the operation of other power generation systems which supply power to the power grid to be controlled. Furthermore, the weather predictions may be used to control other electromechanical apparatus, e.g., to open or close shutter mechanisms.

Another application of the present convolutional sequence model is in a control system for a controlled system. For example, the convolutional sequence model can also be used in a linear dynamic controller. For example, ŷₜ can represent one or more control variables of the controlled system, and u(t) can represent a state of the controlled system, or observation data presenting a state of the controlled system. During the training of the convolutional sequence model, the model can be trained to predict desirable values ŷₜ of the control variable(s), for given values of u(t).

In another example, u(t) is an observed control input to a dynamic system, and ŷₜ is an observation of a system (e.g., an observed linear transformation of the state). During the training of the convolutional sequence model, the model is trained to predict a state ŷₜ of a controlled system, for given choices of the control input u(t).

In some implementations the controlled system is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The convolutional sequence model may be used to control operation of the items of equipment, or to control operation of the ancillary, e.g., environmental, control equipment. This may be done in such a way as to minimize use of a resource, such as electrical power consumption or water consumption.

More generally, the controlled system may be an agent, and the control system may select actions for the agent to perform. The agent may be an electro-mechanical agent which interacts with an environment (e.g., a robot, which may be capable of changing its configuration and of navigating within the environment). In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment. Furthermore, the observations may include sound signals (e.g., collected by one or more microphones of the agent, or microphones that are located separately from the agent in the environment), such as voice commands issued by a human user.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement e.g., braking and/or acceleration of the vehicle.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines. As one example, the convolutional sequence model may control the manufacturing units or machine to manufacture the product or an intermediate version or component thereof. As another example, the model may control the agent to control, e.g., minimize, use of a resource such as a task to control electrical power consumption, or water consumption, or the consumption of any material or consumable used in the manufacturing process.

In some implementations the environment is the real-world environment of a power generation facility, e.g., a renewable power generation facility such as a solar farm or wind farm. The convolutional sequence model may be used to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound pharmaceutically active compound and the agent is a computer system for determining elements of the pharmaceutically active compound and/or a synthetic pathway for the pharmaceutically active compound.

In some applications the agent may be a software agent, e.g., a computer program, configured to perform a task. For example the environment may be a circuit or an integrated circuit design or routing environment and the agent may be configured to perform a design or routing task for routing interconnection lines of a circuit or of an integrated circuit, e.g., an ASIC. The observations may be, e.g., observations of component positions and interconnections; the actions may comprise component placing actions, e.g., to define a component position or orientation and/or interconnect routing actions, e.g., interconnect selection and/or placement actions. The method may include making the circuit or integrated circuit to the design, or with interconnection lines routed as determined by the method.

In some applications the agent is a software agent and the environment is a real-world computing environment. In one example the agent manages distribution of tasks across computing resources, e.g., on a mobile device and/or in a data center. In these applications, the observations may include observations of computing resources such as compute and/or memory capacity, or Internet-accessible resources; and the actions may include assigning tasks to particular computing resources.

In another example the software agent manages the processing, e.g., by one or more real-world servers, of a queue of continuously arriving jobs. The observations may comprise observations of the times of departures of successive jobs, or the time intervals between the departures of successive jobs, or the time a server takes to process each job, e.g., the start and end of a range of times, or the arrival times, or time intervals between the arrivals, of successive jobs, or data characterizing the type of job(s). The actions may comprise actions that allocate particular jobs to particular computing resources.

As another example the environment may comprise a real-world computer system or network, the observations may comprise any observations characterizing operation of the computer system or network, the actions performed by the software agent may comprise actions to control the operation, e.g., to limit or correct abnormal or undesired operation, e.g., because of the presence of a virus or other security breach.

In some applications, the environment is a real-world computing environment and the software agent manages distribution of tasks/jobs across computing resources, e.g., on a mobile device and/or in a data center. In these implementations, the observations may comprise observations that relate to the operation of the computing resources in processing the tasks/jobs, the actions may include assigning tasks/jobs to particular computing resources.

In some applications the environment is a data packet communications network environment, and the agent is part of a router to route packets of data over the communications network. The actions may comprise data packet routing actions and the observations may comprise, e.g., observations of a routing table which includes routing metrics such as a metric of routing path length, bandwidth, load, hop count, path cost, delay, maximum transmission unit (MTU), and reliability.

In some other applications the environment is an Internet or mobile communications environment and the agent is a software agent which manages a personalized recommendation for a user. The observations may comprise previous actions taken by the user, e.g., features characterizing these; the actions may include actions recommending items such as content items to a user.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The design process may include outputting the design for manufacture, e.g., in the form of computer executable instructions for manufacturing the entity. The process may include making the entity according to the design. Thus the design of an entity may be optimized, e.g., by reinforcement learning, and then the optimized design output for manufacturing the entity, e.g., as computer executable instructions; an entity with the optimized design may then be manufactured.

Another application of the present convolutional sequence model is to obtain data characterizing the sequence of data items (i.e., time series analysis). For example, the data items may be sensor data, such as sensor data which is medical data (e.g., electrocardiogram (ECG) measurements at a plurality of respective times), audio data (e.g., captured by a microphone) or image data (e.g., image captured by a camera or medical imaging equipment at respective times).

The characterization data may be such as to indicate that the sequence of data items is in one of a plurality of categories. For example, the convolutional sequence model may indicate that a sequence of electro-cardiogram measurements is in an abnormal category associated with an elevated risk of a medical condition. In another example, the neural network may process a set of data items that represent the pixels of a still or moving image (e.g., in a raster pattern; in the case of a moving image, successive image frames may define respective successive portions of the data item sequence), or that represent audio-visual data, to generate a classification output, e.g., a multi-label classification output, that includes a respective score for each category in a set of categories. The categories in the set of categories can be, e.g., object categories, e.g., corresponding to vehicle, pedestrian, bicyclist, etc. For audio-visual data the categories can comprise event categories, where an event is characterized by a combination of sound and vision, e.g., tool use, a cymbal, a dog barking, fireworks, a crowd cheering, wind blowing, and so forth. The score for an object or event category can define a likelihood that the image depicts an object that belongs to the object category or that an event belongs to the event category.

Alternatively or additionally, the characterization data may identify a (proper) subset of the data items as having a characteristic, e.g., a subset of a sequence of medical images which exhibit a certain characteristic (e.g., in ultrasound images of a heart, images showing times at which the heart malfunctions), and/or identifies a portion of the data items as having a characteristic (e.g., in ultrasound images of an unborn child, a respective portion of the images which shows the heart of the child).

Another application of the present convolutional sequence model is as a language model, in which the sequence of data items is an input sequence of tokens selected from a vocabulary (e.g., a natural language vocabulary), to generate an item embedding (e.g., the item embedding generated by the last layer of the analysis network) using which an output token from a vocabulary (e.g., the same vocabulary or a different vocabulary) is selected, e.g., by the output network. Repeating this process a plurality of times produces an output sequence of output tokens. The process may be recursive, i.e., the selected output tokens may be used to generate a corresponding predicted item embedding, which is processed using the analysis network, to obtain an item embedding (e.g., output by the last processing layer of the analysis network) using which a further output token is selected. In this way, a sequence of output tokens of arbitrary length can be generated. The convolutional sequence model may be a large language model (e.g., a presently known large language model, but using a respective convolutional sequence model as described in place of one or more transformer models of the known large language model). The large language model may include over a billion trained numerical parameters. Furthermore, the convolutional sequence model may be a foundation model, that is trained using a large database of training data (e.g., language training data), such that it can be adapted (e.g., further trained, or used in combination with additional trained layers) for to perform any of a plurality of other “downstream” computational tasks.

In some implementations the input tokens and the output tokens each represent words, wordpieces or characters in a natural language. A wordpiece may be a sub-word (part of a word), and may be an individual letter or character. As used here, “characters” includes Chinese and other similar characters, as well as logograms, syllabograms and the like. The tokens may include marker tokens, such as a start of sequence token, an end of sequence token, and a separator token (indicating a separation or break between two distinct parts of a sequence).

Some of these implementations may be used for natural language tasks such as providing a natural language response to a natural language input, e.g., for question answering, or for text completion. In some implementations the input sequence may represent text in a natural language and the output sequence may represent text in the same natural language, e.g., a longer item of text. For example in some implementations the input sequence may represent text in a natural language and the output sequence may represent the same text with a missing portion of the text added or filled in. For example the output sequence may represent a predicted completion of text represented by the input sequence. Such an application may be used, e.g., to provide an auto-completion function, e.g., for natural language-based search. In some implementations the input sequence may represent a text in a natural language, e.g., posing a question or defining a topic, and the output sequence may represent a text in a natural language which is a response to the question or about the specified topic.

As another example the input sequence may represent a first item of text and the output sequence may represent a second, shorter item of text, e.g., the second item of text may be a summary of a passage that is the first item of text. As another example the input sequence may represent a first item of text and the output sequence may represent a simplification of the first item of text. As another example the input sequence may represent a first item of text and the output sequence may represent an aspect of the first item of text, e.g., it may represent an entailment task, a paraphrase task, a textual similarity task, a sentiment analysis task, a sentence completion task, a grammaticality task, a parsing task, e.g., constituency parsing, and in general any natural language understanding task that operates on a sequence of text in some natural language, e.g., to generate an output that classifies or predicts some property of the text. For example some implementations may be used to identify a natural language of the first item of text, or of spoken words where the input is audio.

Some implementations may be used to perform neural machine translation. Thus in some implementations the input tokens represent words, wordpieces, or characters in a first natural language and the output tokens represent words, wordpieces or characters in a second, different natural language. That is, the input sequence may represent input text in the first language and the output sequence may represent a translation of the input text into the second language.

Some implementations may be used for automatic code generation. For example the input tokens may represent words, wordpieces or characters in a first natural language and the output tokens may represent instructions in a computer programming or markup language, or instructions for controlling an application program to perform a task, e.g., build a data item such as an image or web page.

Some implementations may be used for speech recognition. In such applications the input sequence may represent spoken words and the output sequence may represent a conversion of the spoken words to a machine-written representation, e.g., text. Then the input tokens may comprise tokens representing an audio data input including the spoken words, e.g., characterizing a waveform of the audio in the time domain or in the time-frequency domain. The output tokens may represent words, wordpieces, characters, or graphemes of a machine-written, e.g., text, representation of the spoken input, that is representing a transcription of the spoken input.

Some implementations may be used for handwriting recognition. In such applications the input sequence may represent handwritten words, syllabograms or characters and the output sequence may represent a conversion of the input sequence to a machine-written representation, e.g., text. Then the input tokens may comprise tokens representing portions of the handwriting and the output tokens may represent words, wordpieces, characters or graphemes of a machine-written, e.g., text, representation of the spoken input.

Some implementations may be used for text-to-speech conversion. In such applications the input sequence may represent text and the output sequence may represent a conversion of the text to spoken words. Then the input tokens may comprise tokens representing words or wordpieces or graphemes of the text and the output tokens may represent portions of audio data for generating speech corresponding to the text, e.g., tokens characterizing a portion of a waveform of the speech in the time domain or in the time-frequency domain, or phonemes.

In some implementations the input sequence and the output sequence represent different modalities of input. For example the input sequence may represent text in a natural language and the output sequence may represent an image or video corresponding to the text; or vice-versa. In general the tokens may represent image or video features and a sequence of such tokens may represent an image or video. There are many ways to represent an image (or video) using tokens. As one example an image (or video) may be represented as a sequence of regions of interest (Rols) in the image, optionally including one or more tokens for global image features. For example an image may be encoded using a neural network to extract Rol features; optionally (but not essentially) a token may also include data, e.g., a position encoding, representing a position of the Rol in the image. As another example, the tokens may encode color or intensity values for pixels of an image. As another example, some image processing neural network systems, e.g., autoregressive systems, naturally represent images as sequences of image features.

Thus in some implementations at least one of the input sequence and the output sequence is a sequence representing an image or video, and the tokens represent the image or video. For example the input sequence may be a sequence of text, the input tokens may represent words, wordpieces, or characters and the output sequence may comprise output tokens representing an image or video, e.g., described by the text, or providing a visual answer to a question posed by the text, or providing a visualization of a topic of the text. In another example the input sequence may comprise a sequence of input tokens representing an image or video, and the output tokens may represent words or wordpieces, or characters representing text, e.g., for a description or characterization of the image or video, or providing an answer to a question posed visually by the image or video, or providing information on a topic of a topic of the image or video.

In some other implementations both the input sequence and the output sequence may represent an image or video, and both the input tokens and the output tokens may represent a respective image or video. In such implementations the method/system may be configured to perform an image or video transformation. For example the input sequence and the output sequence may represent the same image or video in different styles, e.g., one as an image the other as a sketch of the image; or different styles for the same item of clothing.

In some implementations the input sequence represents data to be compressed, e.g., image data, text data, audio data, or any other type of data; and the output sequence a compressed version of the data. The input and output tokens may each comprise any representation of the data to be compressed/compressed data, e.g., symbols or embeddings generated/decoded by a respective neural network.

In some implementations the input sequence represents a sequence of actions to be performed by an agent, e.g., a mechanical agent in a real-world environment implementing the actions to perform a mechanical task. The output sequence may comprise a modified sequence of actions, e.g., one in which an operating parameter, such as a speed of motion or power consumption, has a limited value; or one in which or safety or other boundary is less likely to be crossed. Then both the input tokens and the output tokens may represent the actions to be performed.

In some implementations the input sequence represents a sequence of health data and the output sequence may comprise a sequence of predicted treatment. Then the input tokens may represent any aspect of the health of a patient, e.g., data from blood and other medical tests on the patient and/or EHR (Electronic Health Record) data; and the output tokens may represent diagnostic information, e.g., relating to a disease status of the patient and/or relating to suggested treatments for the patient, and/or relating to a likelihood of an adverse health event for the patient.

In some implementations the input sequence represents a time series and the output sequence may comprise a continuation of the time series. For example the input sequence may be a sequence representing the output of an electricity generating plant, e.g., a solar or wind electricity generating plant, or a sequence representing electricity consumption, and the output sequence may provide a forecast of the electricity generated or consumed. As another example, the input sequence may be a sequence representing a level of traffic on one or more roads and the output sequence may provide a forecast of the future traffic.

In some cases, the operation of the model may be conditioned on a media item (e.g., a still or moving image and/or audio data), so that the convolutional sequence model operates as a multi-modal language model.

Another application of the present convolutional sequence model is as a generative model for generating a media item (e.g., comprising a still or moving image and/or audio data; and optionally additionally comprising tokens selected from a vocabulary) or generating an item of language (e.g., a passage of text made up of tokens) by selecting a series of tokens from a vocabulary. Successive outputs of the convolutional sequence model may be used to generate successive elements of the media items and/or select successive tokens from the vocabulary. For example, the elements may be one or more intensity values for each pixel of an image, or a pixel of a frame of a moving image. The successive elements may correspond to the pixels in a raster pattern; in the case of a moving image, successive image frames may define respective successive portions of the output sequence of the convolutional sequence model. In another example, the elements may define one or more values (e.g., Fourier components) characterizing a corresponding time portion of the audio data.

As in some other applications above, outputs of the convolutional sequence model can be fed back recursively, e.g., outputs of the output network can be fed back to the embedding network as new data items of the sequence (i.e., data items which follow the initial data items in the sequence of data items), or image embedding outputs of the analysis network can be fed back to be image embeddings which are input to the first layer of the analysis network.

One or more data items of the sequence (e.g., one or more initial data items of the sequence) may be used to condition the generation of the media item or item of language, while optionally later data items of the sequence may be based on elements of the media item which have already been generated and/or tokens which have been selected. Thus, the one or more data items (i.e., data items which are not generated based on outputs of the analysis network) determine which media item or item of language is generated. These one or more data items of the sequence (e.g., an initial one or more of the data items in the sequence) may each comprise one or more tokens selected from a vocabulary (e.g., a vocabulary of the types discussed above, such as natural language tokens), e.g., by a user. In this way, the media item is generated conditioned on these tokens. For example, a still or moving image, or audio data, can be generated conditioned on data items in the sequence which are based on selected tokens, e.g., as an image described by the data items, or as sound based on (e.g., a reading out of, or which is described by) the data items.

### Example Machine Learned Models and Machine Learning Systems

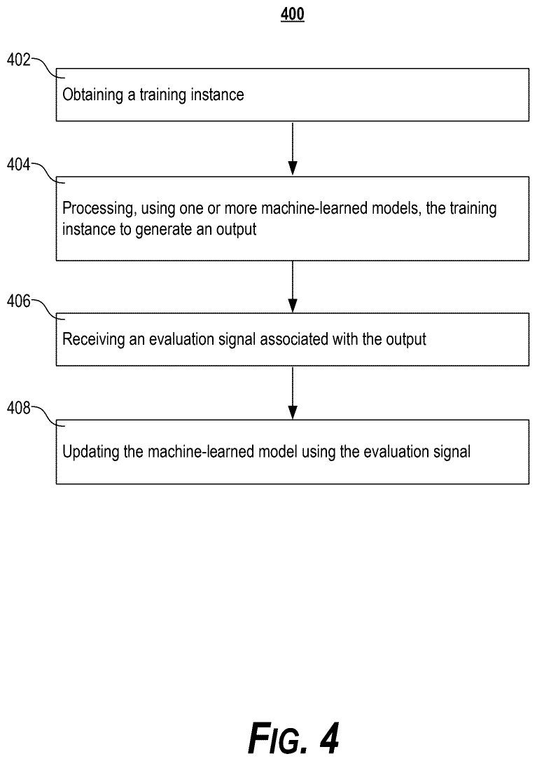

FIG. 4 depicts a flowchart of a method 400 for training one or more machine-learned models according to aspects of the present disclosure. For instance, an example machine-learned model can include a convolutional sequence model.

One or more portion(s) of example method 400 can be implemented by a computing system that includes one or more computing devices such as, for example, computing systems described with reference to the other figures. Each respective portion of example method 400 can be performed by any (or any combination) of one or more computing devices. Moreover, one or more portion(s) of example method 400 can be implemented on the hardware components of the device(s) described herein, for example, to train one or more systems or models. FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 4 is described with reference to elements/terms described with respect to other systems and figures for exemplary illustrated purposes and is not meant to be limiting. One or more portions of example method 400 can be performed additionally, or alternatively, by other systems.

At 402, example method 400 can include obtaining a training instance. A set of training data can include a plurality of training instances divided between multiple datasets (e.g., a training dataset, a validation dataset, or testing dataset). A training instance can be labeled or unlabeled. Although referred to in example method 400 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 404, example method 400 can include processing, using one or more machine-learned models, the training instance to generate an output. The output can be directly obtained from the one or more machine-learned models or can be a downstream result of a chain of processing operations that includes an output of the one or more machine-learned models.

At 406, example method 400 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 408, example method 400 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 400 can include implementing a number of generalization techniques (e.g., weight decays, dropouts, etc.) to improve the generalization capability of the models being trained.

In some implementations, example method 400 can be implemented for training a machine-learned model from an initialized state to a fully trained state (e.g., when the model exhibits a desired performance profile, such as based on accuracy, precision, recall, etc.).

In some implementations, example method 400 can be implemented for particular stages of a training procedure. For instance, in some implementations, example method 400 can be implemented for pre-training a machine-learned model. Pre-training can include, for instance, large-scale training over potentially noisy data to achieve a broad base of performance levels across a variety of tasks/data types.

In some implementations, example method 400 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 400 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 400 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

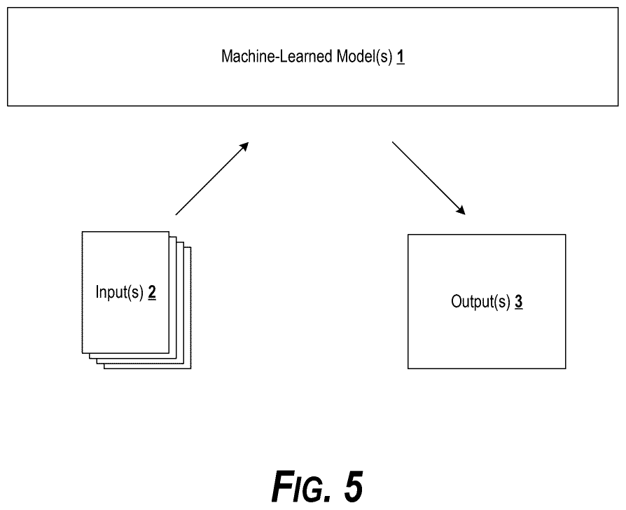

FIG. 5 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of the convolutional sequence models described herein, etc. Although various features, variations, and implementations described below are described with respect to machine-learned model(s) 1, it is to be understood that such features, variations, and implementations are to be understood as described with respect to each of one or more of the convolutional sequence models described herein, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

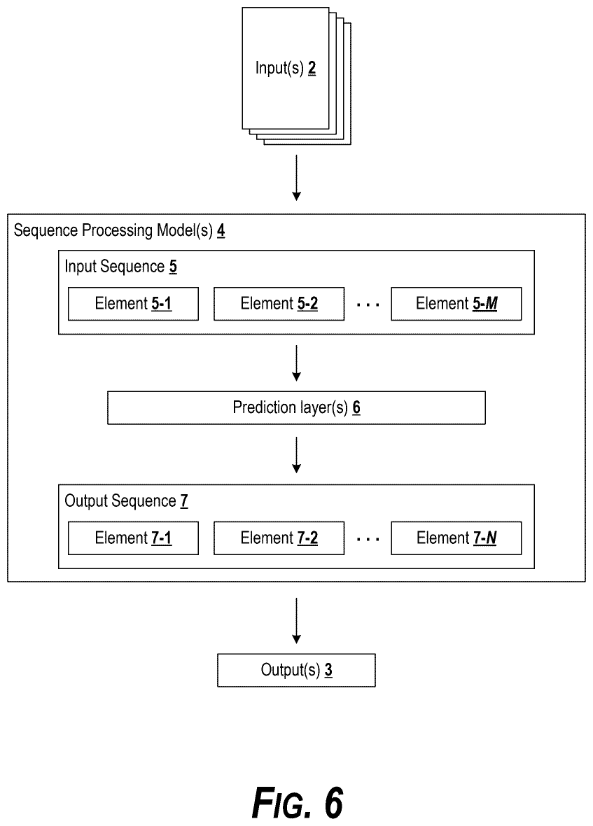

FIG. 6 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, GOOGLE, https://arxiv.org/abs/2403.08295; Gemma 2: Improving Open Language Models at a Practical Size, GOOGLE, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, GOOGLE, https://arxiv.org/abs/2407.07726; PaliGemma 2: A Family of Versatile VLMs for Transfer, GOOGLE, https://arxiv.org/abs/2412.03555; Flamingo: a Visual Language Model for Few-Shot Learning, GOOGLE, https://arxiv.org/abs/2204.14198; PaLI: A Jointly-Scaled Multilingual Language-Image Model, GOOGLE, https://arxiv.org/abs/2209.06794.

Sequence processing model(s) 4 can be multimodal. Example multimodal sequence processing models include, for instance, models described in Gemini: A Family of Highly Capable Multimodal Models, GOOGLE, https://arxiv.org/abs/2312.11805; Gemini 1.5: Unlocking multimodal understanding across millions of tokens of context, GOOGLE, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 6 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

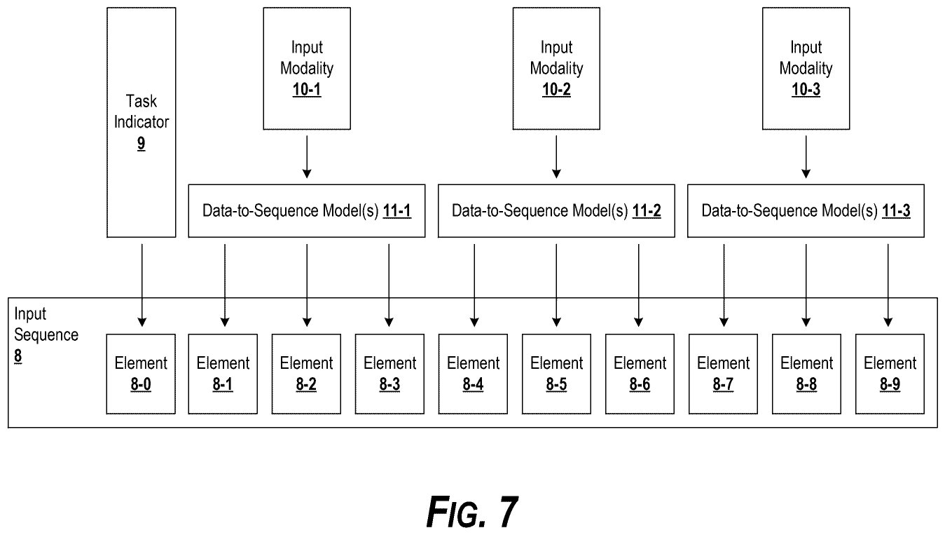

FIG. 7 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

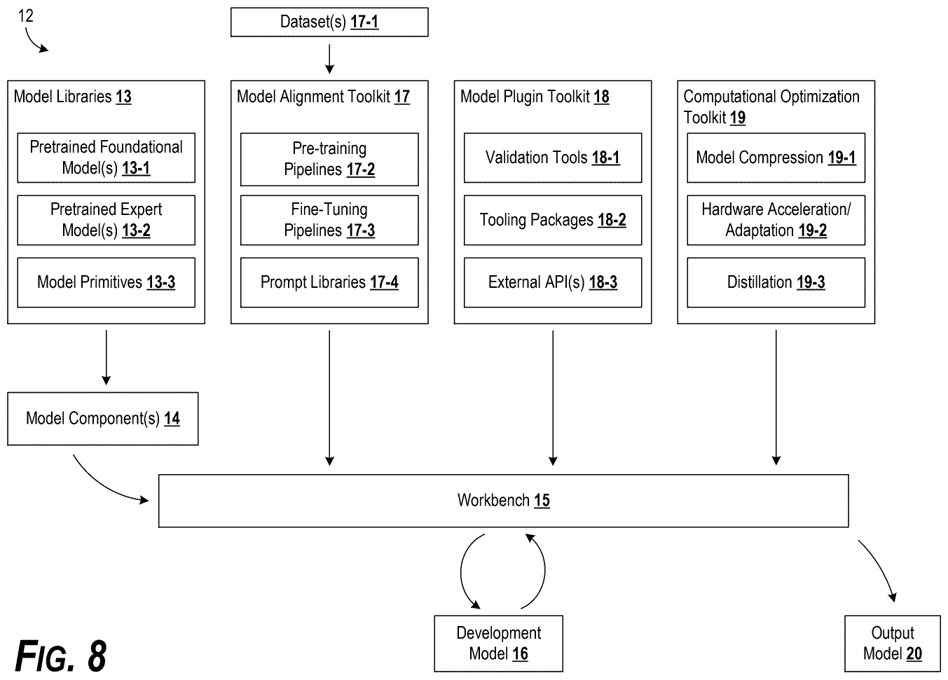

FIG. 8 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 400 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task-while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

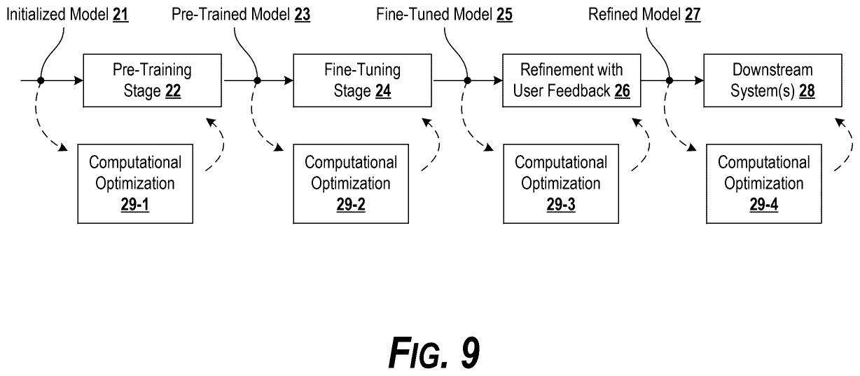

FIG. 9 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

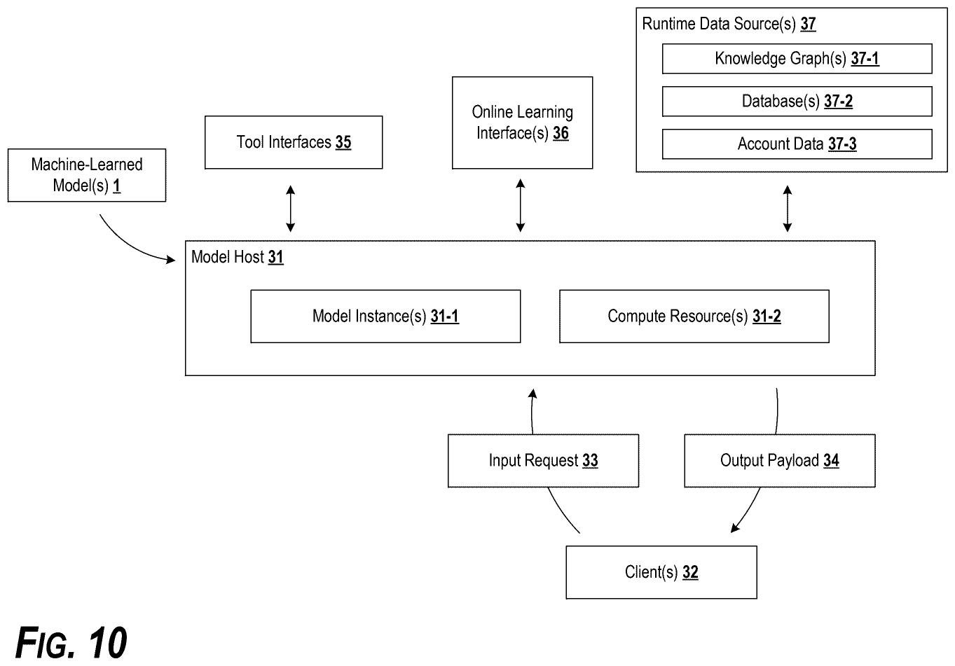

FIG. 10 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

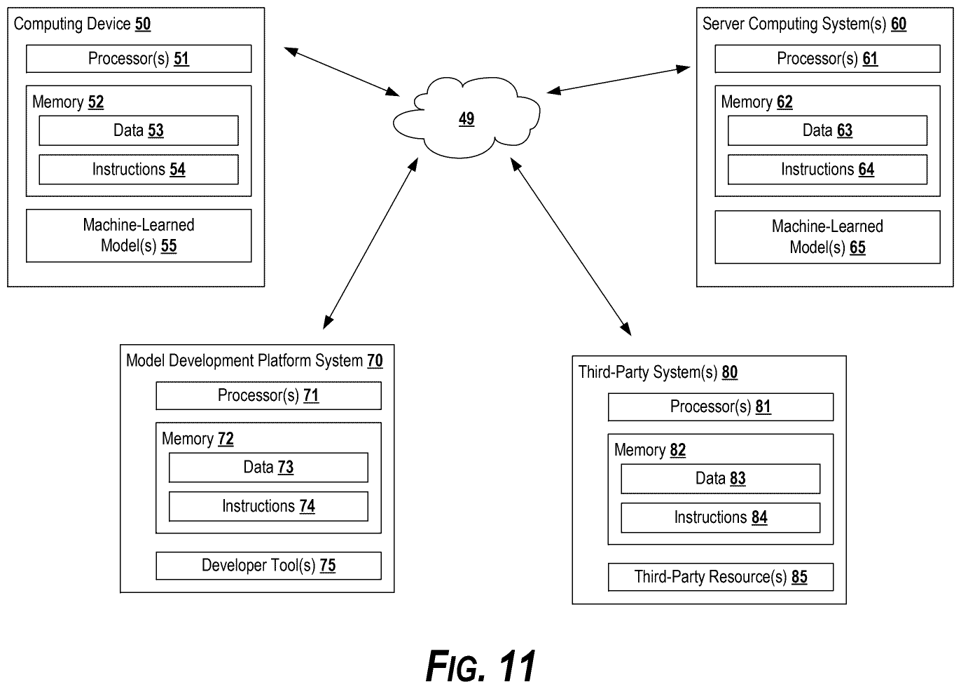

FIG. 11 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 11 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM,

EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 11 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

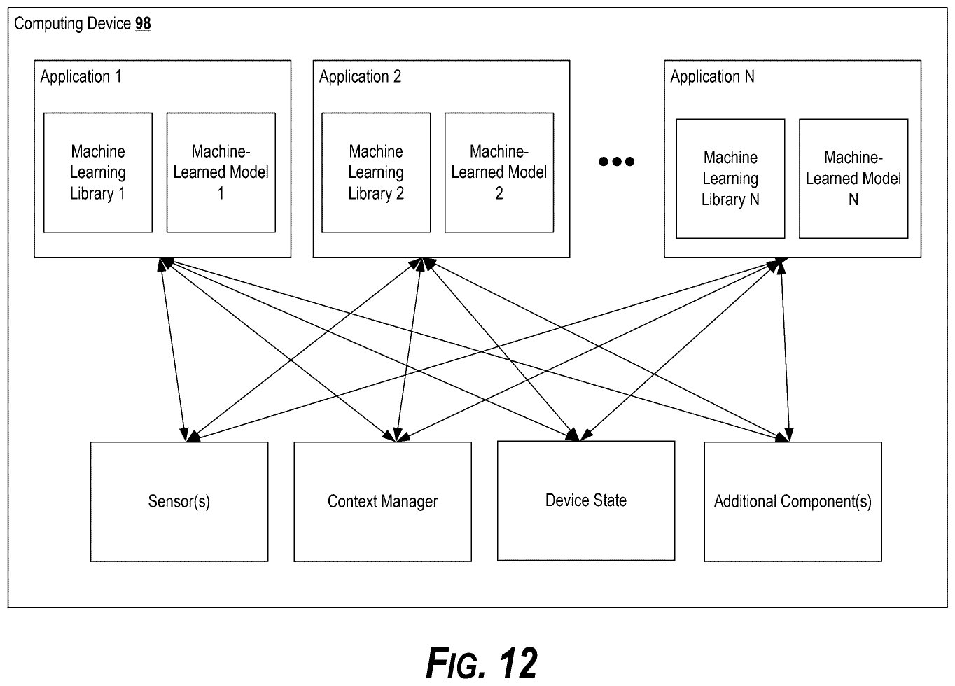

FIG. 12 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 12, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

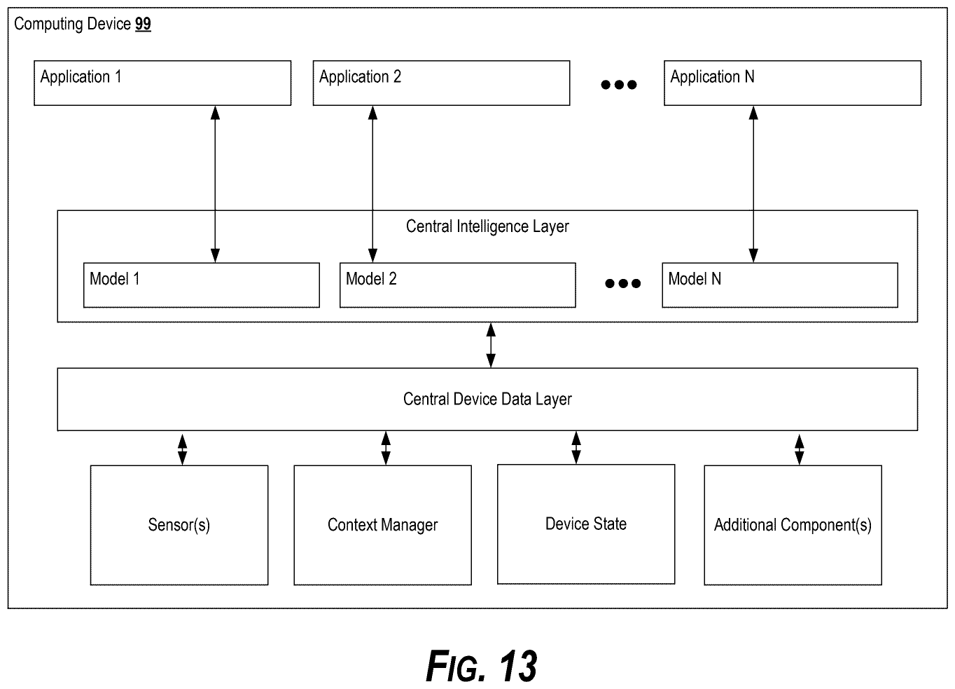

FIG. 13 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 13, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 13, the central device data layer can communicate with a number of other components of the computing device, such as, for example, one or more sensors, a context manager, a device state component, or additional components. In some implementations, the central device data layer can communicate with each device component using an API (e.g., a private API).

### Additional Descriptions

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for performing autoregressive generation with a convolutional sequence model, the method comprising:
obtaining, by a computing system comprising one or more computing devices, a current context vector comprising a plurality of context data items;
pre-computing, by the computing system, a convolution between the input context and a filter of the convolutional sequence model to pre-cache a plurality of inner products respectively between the filter and a plurality of padded context vectors; and
for each of a plurality of output values:
determining, by the computing system, the output value based on a sum of one of the pre-cached inner products with one or more additional component products respectively generated by multiplication of the filter with one or more preceding context data items that precede the output value.

2. The computer-implemented method of claim 1, wherein, for a first sequential output value of the plurality of output values, the one or more preceding context data items consist of a final context data item of the plurality of context data items.

3. The computer-implemented method of claim 1, wherein, for a second or later sequential output value of the plurality of output values, the one or more preceding context data items consist of a final context data item of the plurality of context data items and all preceding output values of the plurality of output values.

4. The computer-implemented method of claim 1, further comprising updating, by the computing system, the current context vector to include the plurality of output values.

5. The computer-implemented method of claim 1, wherein pre-computing the convolution comprises performing a Fast Fourier Transform algorithm.

6. The computer-implemented method of claim 1, wherein the filter of the convolutional sequence model comprises a spectral filter.

7. The computer-implemented method of claim 1, wherein the filter of the convolutional sequence model comprises a fixed-value filter.

8. The computer-implemented method of claim 1, wherein determining each output value comprises determining the output value further based on multiplication of one or more learned projection matrices and the sum.

9. The computer-implemented method of claim 1, wherein pre-computing the convolution comprises generating the plurality of padded context vectors by padding respective subportions of the current context vector.

10. The computer-implemented method of claim 1, wherein the current context vector comprises textual tokens associated with a textual content.

11. The computer-implemented method of claim 1 except the immediately prior preceding claim, wherein the current context vector comprises a sequence embedding generated by one or more preceding layers of the convolutional sequence model that precede a spectral analysis layer that includes the filter.

12. The computer-implemented method of claim 1, wherein each output value comprises a classification output.

13. The computer-implemented method of claim 1, wherein each output value comprises a predicted token.

14. The computer-implemented method of claim 1, wherein determining, by the computing system, the plurality of output values comprises performing batch generation of output values.

15. The computer-implemented method of claim 1, wherein said operations of obtaining the current context vector, pre-computing the convolution, and determining the plurality of output values are iteratively performed over a number of online generation periods.

16. The computer-implemented method of claim 15, wherein the online generation periods have a periodicity equal to a threshold number of output values.

17. The computer-implemented method of claim 15, wherein each online generation period further comprises evaluating, by the computing system, a loss function that compares the output values to ground truth values.

18. One or more non-transitory computer-readable media that collectively store computer-executable instructions for performing operations, the operations comprising, for each of a plurality of iterations:
determining whether an output counter exceeds a threshold value;
when the output counter satisfies the threshold value:
pre-computing, by the computing system, a convolution between a current context vector and a filter of a convolutional sequence model to pre-cache a plurality of inner products respectively between the filter and a plurality of padded context vectors; and
resetting the output counter; and
when the output counter does not satisfy the threshold value:
determining, by the computing system, a next sequential output value based on a sum of one of the pre-cached inner products with one or more additional component products generated by multiplication of the filter with one or more preceding context data items;
updating the current context vector to include the next sequential output value; and
increasing the output counter.

19. The one or more non-transitory computer-readable media of claim 18, wherein the threshold value is equal to a square root of a context length associated with the filter.

20. A computing system for processing a sequence of data items corresponding to a plurality of time steps, the computing system comprising a neural network model and configured to perform operations for successive time steps, the operations comprising:
processing an initial item embedding based on the data item for the time step using an analysis network of the neural network model comprising a plurality of processing layers arranged in a sequence, each processing layer performing a function defined by a corresponding set of trained numerical parameters, a first processing layer of the sequence being configured to receive the initial item embedding, and to output a corresponding modified item embedding, and each other processing layer of the sequence being configured to receive the item embedding output by the preceding layer of the sequence and output a corresponding modified item embedding;
wherein at least one of the processing layers is a spectral analysis layer which, for each generation period that spans a plurality of time steps:
obtains a current context vector comprising a plurality of context data items;
pre-computes a convolution between the input context and a filter of the convolutional sequence model to pre-cache a plurality of inner products respectively between the filter and a plurality of padded context vectors; and
for each of the plurality of time steps:
determines an output value for that time step based on a sum of one of the pre-cached inner products with one or more additional component products respectively generated by multiplication of the filter with one or more preceding context data items associated with preceding time steps.
